(19) United States
(12) Patent Application Publication
(10) Pub. No.: US 2026/0004376 A1
(43) Pub. Date: Jan. 1, 2026

(54) ELECTRIC VEHICLE CHARGING AND DISCHARGING APPARATUS AND METHOD LINKING RIDE-SHARING SERVICE AND VEHICLE-TO-GRID

(71) Applicants: HYUNDAI MOTOR COMPANY, Seoul (KR); Kia Corporation, Seoul (KR); Gwangju Institute of Science and Technology, Gwangju (KR)

(72) Inventors: Jaehyuk CHOI, Hwaseong-si (KR); Euiseok HWANG, Gwangju (KR); Seungwook YOON, Gwangju (KR); Dongju KIM, Gwangju (KR)

(73) Assignees: HYUNDAI MOTOR COMPANY, Seoul (KR); Kia Corporation, Seoul (KR); Gwangju Institute of Science and Technology, Gwangju (KR)

(21) Appl. No.: 18/954,358

(22) Filed: Nov. 20, 2024

(30) Foreign Application Priority Data
Jun. 28, 2024 (KR) 10-2024-0085120

(51) Int. Cl. G06Q 50/43; B60L 53/64; G06Q 30/0202; G06Q 40/12; H02J 3/00

(52) U.S. Cl. CPC G06Q 50/43; G06Q 30/0202; H02J 3/003; B60L 53/64; G06Q 40/12

(57) ABSTRACT

An electric vehicle charging and discharging apparatus for linking ride-sharing service and vehicle-to-grid may include a processor and a memory storing software, when executed by the processor, causing the processor to collect power data of buildings, predict power consumption of the buildings based on the power data, respectively, calculate a time zone in which an additional power is required for each of the buildings and a required amount of electrical power based on the collected power data and the predicted power consumption, estimate a travel demand of a region where the buildings exist, and set a travel path of a ride-sharing vehicle for each time zone within the region based on the time zone requiring the additional power, the required amount of electrical power and the travel demand.

### CROSS-REFERENCE TO RELATED APPLICATION

This application claims priority to and the benefit of Korean Patent Application No. 10-2024-0085120 filed in the Korean Intellectual Property Office on Jun. 28, 2024, the entire contents of which is incorporated herein by reference.

### BACKGROUND OF THE INVENTION

### (a) Field of the Invention

The present disclosure relates to an electric vehicle charging and discharging apparatus and method linking ride-sharing service and vehicle-to-grid. More particularly, the present disclosure relate to an electric vehicle charging and discharging apparatus and method linking ride-sharing service and vehicle-to-grid, which provides a ride-sharing service and vehicle-to-grid (V2G) service by utilizing batteries of electric vehicles that can be parked in buildings within a microgrid.

### (b) Description of the Related Art

Electric vehicles use battery power to drive a motor for movement. The batteries of electric vehicles are gradually becoming larger for long-distance driving, and electric vehicles that drive short distances do not require a large energy to reach the next destination.

Therefore, when the surplus power of the battery is discharged in the time zone of large power consumption, degradation of power facilities may be prevented while the facility operation rate may be reduced, and electric vehicle owners may reduce the cost for operating the electric vehicle through the discharging fee.

With the advancement of information and communication technology, electronic devices and facilities are being added to buildings, and power consumption is gradually increasing due to the added facilities.

Building managers must increase the capacity of power equipment (e.g., transformers) or increase contracted power to handle increasing power usage. Due to this increase in facilities and updates to contract information, building managers' power bills will increase and technologies to mitigate this will be needed.

Additionally, as interest in the sharing economy increases, the market for ride-sharing services is growing.

### SUMMARY OF THE INVENTION

The present disclosure attempts to provide an electric vehicle charging and discharging apparatus and method linking ride-sharing service and vehicle-to-grid capable of moving passengers to a desired location through ride-sharing service utilizing electric vehicles, and lower the power usage of a building by discharging the battery of electric vehicle.

An electric vehicle charging and discharging apparatus for linking ride-sharing service and vehicle-to-grid may include a processor and a memory, storing software, when executed by the processor, causing the processor to collect power data of buildings, predict power consumption of the buildings based on the power data, respectively, calculate a time zone in which an additional power is required for each of the buildings and a required amount of electrical power based on the collected power data and the predicted power consumption, estimate a travel demand of a region where the buildings exist, and set a travel path of a ride-sharing vehicle for each time zone within the region based on the time zone requiring the additional power, the required amount of electrical power and the travel demand.

The processor may be configured to collect location data of respective buildings for estimation of past power usage data, power facility data, contacted power data and the travel demand of respective buildings, for power prediction.

The processor may be configured to predict a power usage pattern during a specific period for each of the buildings by using the collected past power usage data.

The processor may be configured to estimate the time zone requiring discharging of each of the buildings and the amount of electrical power in consideration of the power facility data and the contacted power data with respect to each of the buildings.

The processor may be configured to collect public transportation demand data and ride-sharing service participation record data according to regions, for each time zone, to generate travel demand information.

The processor may be configured to estimate an actual travel demand when the ride-sharing vehicle performs movement between building in consideration of the generated travel demand information.

The processor may be configured to estimate the travel demand through Equation 1 below by using the number of persons to depart from a departure region and the number of persons to move to another region,

$${X}_{A \to B} = \frac{Arrival {quantity}_{B}}{{\sum }_{n \neq A} Arrival {quantity}_{B}} \times Departure {quantity}_{A} \qquad [ Equation 1 ]$$

where A and B denote buildings, X denotes a travel demand quantity, X_{A→B} denotes a travel demand quantity when moving from A to B, n denotes a set of all buildings, an Arrival quantity_{B} is the number of persons moving to a building B, an Arrival quantityₙ is the number of persons moving to all the buildings, and a Departure quantity_{A} is the number of persons to depart from a building A.

The processor may be configured to set a travel path maximizing profitability, and the profitability is calculated through Equation 2 below,

$$profitability = passenger boarding fee + electric vehicle disharging fee + a service fee of building manager - electric vehicle battery degradation cost - electric vehicle charging cost - electric vehicle operating cost . \qquad [ Equation 2 ]$$

The processor may be configured to use an optimization model including reinforcement learning, auction model, and linear programming, in order to set the travel path.

An electric vehicle charging and discharging apparatus for linking ride-sharing service and vehicle-to-grid may be configured to guide the predetermined path to a customer terminal, and perform reservation with respect to a passenger to use the ride-sharing vehicle according to the path predetermined for each time zone.

An electric vehicle charging and discharging method for linking ride-sharing service and vehicle-to-grid may include collecting power data of buildings, predicting power consumption of the buildings based on the power data, respectively, calculating a time zone in which an additional power is required for each of the buildings and a required amount of electrical power based on the collected power data and the predicted power consumption, estimating a travel demand of a region where the buildings exist, and setting a travel path of a ride-sharing vehicle for each time zone within the region based on the time zone requiring the additional power, the required amount of electrical power and the travel demand.

The collecting the power data may include collecting location data of respective buildings for estimation of past power usage data, power facility data, contacted power data and the travel demand of respective buildings, for power prediction.

The predicting the power consumption of the buildings, respectively, may include predicting a power usage pattern during a specific period for each of the buildings by using the collected past power usage data.

In the calculating the time zone requiring the additional power and the required amount of electrical power, the time zone requiring discharging of each of the buildings and the amount of electrical power are estimated in consideration of the power facility data and the contacted power data with respect to each of the buildings.

The estimating the travel demand may include generating travel demand information by collecting public transportation demand data and ride-sharing service participation record data according to regions, for each time zone.

The estimating the travel demand may further include estimating an actual travel demand when the ride-sharing vehicle performs movement between building in consideration of the generated travel demand information.

The estimating the travel demand may further include estimating the travel demand through Equation 1 below by using the number of persons to depart from a departure region and the number of persons to move to another region,

$${X}_{A \to B} = \frac{Arrival {quantity}_{B}}{{\sum }_{n \neq A} Arrival {quantity}_{B}} \times Departure {quantity}_{A} \qquad [ Equation 1 ]$$

where A and B denote buildings, X means a travel demand quantity, X_{A→B} denotes a travel demand quantity when moving from A to B, and n denotes a set of all buildings, where an Arrival quantity_{B} is the number of persons moving to a building B, an Arrival quantityₙ is the number of persons moving to all the buildings, and a Departure quantity_{A} is the number of persons to depart from a building A.

The setting the travel path may include setting a travel path maximizing profitability, and the profitability is calculated through Equation 2 below:

$$profitability = passenger boarding fee + electric vehicle disharging fee + a service fee of building manager - electric vehicle battery degradation cost - electric vehicle charging cost - electric vehicle operating cost . \qquad [ Equation 2 ]$$

The setting the travel path may include setting the travel path by using an optimization model including reinforcement learning, auction model, and linear programming.

An electric vehicle charging and discharging method for linking ride-sharing service and vehicle-to-grid may further include guiding a predetermined path to a customer terminal, and performing reservation with respect to a passenger to use the ride-sharing vehicle according to the path predetermined for each time zone.

An electric vehicle charging and discharging apparatus and method linking ride-sharing service and vehicle-to-grid according to an embodiment may move passengers to desired locations and lower the power consumption of the building by discharging the battery of the electric vehicles, through ride-sharing service using electric vehicles.

An electric vehicle charging and discharging apparatus and method linking ride-sharing service and vehicle-to-grid according to an embodiment may provide very high efficiency by moving persons and lower the power consumption by identifying a region where the moving demand of people is high and power consumption is high

An electric vehicle charging and discharging apparatus and method linking ride-sharing service and vehicle-to-grid according to an embodiment may utilize ride-sharing electric vehicles, instead of or in addition to personal vehicles, for the V2G service, thereby facilitating service application of access.

### BRIEF DESCRIPTION OF THE DRAWINGS

FIG. 1 schematically shows an electric vehicle charging and discharging system linking a ride-sharing service and V2G according to an embodiment.

FIG. 2 is a block diagram of an electric vehicle charging and discharging apparatus linking a ride-sharing service and V2G according to an embodiment.

FIG. 3 is a flowchart of an electric vehicle charging and discharging method linking a ride-sharing service and V2G according to an embodiment.

FIG. 4 is a drawing showing a signal flow of a process of collecting data of a service-participating building according to an embodiment.

FIG. 5 is a drawing showing a signal flow of an electric vehicle charging and discharging method linking a ride-sharing service and V2G according to an embodiment.

FIG. 6 shows graphs of power data of buildings according to an embodiment.

FIG. 7 shows graphs of public transportation usage by regions according to an embodiment.

FIG. 8 is drawing for explaining a computing device according to an embodiment.

### DETAILED DESCRIPTION OF THE EMBODIMENTS

An embodiment of the disclosure will be described more fully hereinafter with reference to the accompanying drawings such that a person skill in the art may easily implement the embodiment. As those skilled in the art would realize, the described embodiments may be modified in various different ways, all without departing from the spirit or scope of the present disclosure. In order to clarify the present disclosure, parts that are not related to the description will be omitted, and the same elements or equivalents are referred to with the same reference numerals throughout the specification.

In addition, unless explicitly described to the contrary, the word “comprise” and variations such as “comprises” or “comprising” will be understood to imply the inclusion of stated elements but not the exclusion of any other elements. Terms including an ordinary number, such as first and second, are used for describing various constituent elements, but the constituent elements are not limited by the terms. The terms are only used to differentiate one component from other components.

In addition, the terms “unit”, “part” or “portion”, “-er”, and “module” in the specification refer to a unit that processes at least one function or operation, which may be implemented by hardware, software, or a combination of hardware and software.

Hereinafter, embodiments of the present disclosure will be described with reference to the drawings.

In this disclosure, an electric vehicle charging and discharging apparatus linking a ride-sharing service and a V2G may frequently referred to as a service manager.

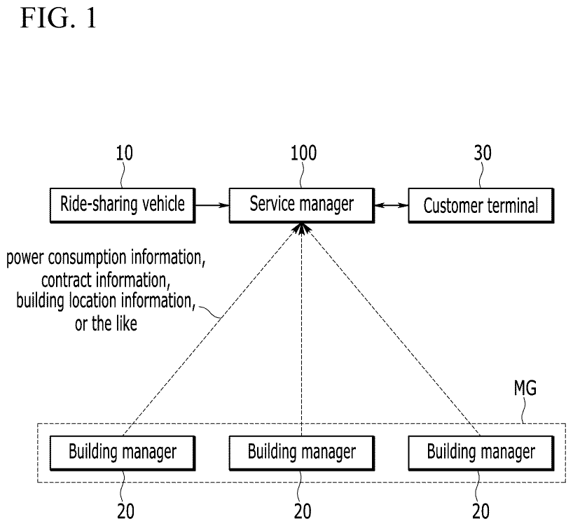

FIG. 1 schematically shows an electric vehicle charging and discharging system linking the ride-sharing service and the V2G according to an embodiment.

The electric vehicle charging and discharging system linking the ride-sharing service and the V2G may provide the electric vehicle charging and discharging service linking the ride-sharing service and the V2G.

The electric vehicle charging and discharging system linking the ride-sharing service and the V2G may manage the electric vehicle charging and discharging service linking the ride-sharing service and the V2G through the electric vehicle charging and discharging apparatus linking the ride-sharing service and the V2G.

Referring to FIG. 1, the electric vehicle charging and discharging system linking the ride-sharing service and the V2G may include a ride-sharing vehicle 10, a building manager 20, a customer terminal 30 and a service manager 100.

The ride-sharing vehicle 10 may include an electric vehicle. The ride-sharing vehicle 10 may be a vehicle provided for the ride-sharing service. The ride-sharing vehicle 10 may be disposed to provide the ride-sharing service to a plurality of regions in which a plurality of buildings are disposed, respectively.

The building manager 20 may be a server that has comprehensive data of the building. The building manager 20 may include, for example, a building power measurement system or equipment.

For example, the building manager 20 may be provided as a server operating the buildings within a microgrid MG.

The building manager 20 may be operation systems of the buildings registered to participate in the electric vehicle charging and discharging service linking the ride-sharing service and the V2G according to the present disclosure.

The building manager 20 may be in a plural quantity, and may exist in respective different regions.

The building manager 20 may provide information including power data with respect to the building necessary for the service to the service manager 100.

The customer terminal 30 may include a mobile phone, a tablet, a computer, or the like in which an application providing the ride-sharing service is installed.

Through the customer terminal 30, the customer may be provided with the travel path of the ride-sharing vehicle, and may reserve the ride-sharing service, as required.

The service manager 100 may correspond to an electric vehicle charging and discharging apparatus 100 linking the ride-sharing service and the V2G. That is, the service manager 100 may manage the electric vehicle charging and discharging service linking the ride-sharing service and the V2G.

The service manager 100 may simultaneously manage the ride-sharing service and the V2G service. The service manager 100 may connect the ride-sharing service and the V2G system.

The service manager 100 may provide and manage a service capable of moving passengers to a desired location by using the ride-sharing service, and lowering the power consumption of the building by discharging the battery of electric vehicle through the V2G technology.

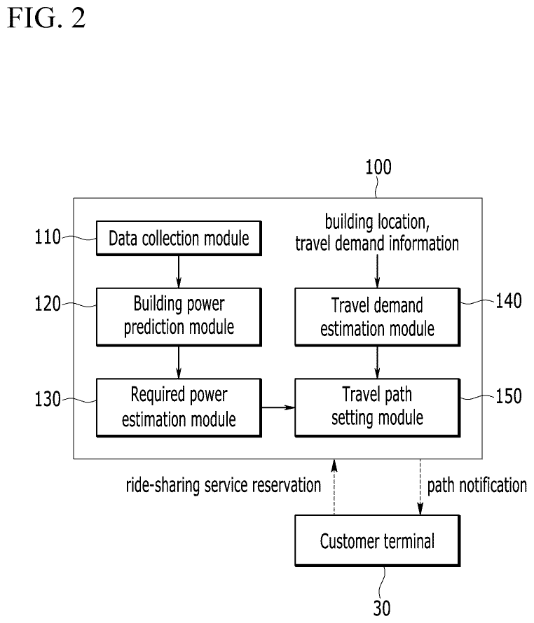

FIG. 2 is a block diagram of an electric vehicle charging and discharging apparatus linking the ride-sharing service and the V2G according to an embodiment.

Referring to FIG. 2, the electric vehicle charging and discharging apparatus 100 linking the ride-sharing service and the V2G may include a data collection module 110, a building power prediction a module 120, a required power estimation module 130, a travel demand estimation module 140 and a travel path setting module 150.

The data collection module 110 may collect the power data of the buildings.

The data collection module 110 may collect the power data with respect to each of the buildings from the building manager 20 (see FIG. 1). The power data may include various data related to the electrical power of the buildings used in the power grid.

The data collection module 110 may collect past power usage data, power facility data, contacted power data, or the like of each of the buildings, for power prediction.

The past power usage data may include past power consumption of the building for a preset period. The power facility data may include the capacity of the power facility. The contacted power data may include power contract content of the building.

The data collection module 110 may collect location data of each of the buildings for estimating the travel demand. The location data may include information on the region where the building is located.

The building power prediction module 120 may predict power consumption of the buildings based on the power data, respectively. The building power prediction module 120 may predict the current and/or future power consumption based on the power data including past power consumption, power facility capacity and power contract of each of the buildings.

For example, the building power prediction module 120 may predict a power usage pattern during a specific period for building each by using the collected past power usage data.

The building power prediction module 120 may predict the power usage pattern of the building for a specific period (e.g., a day, 12 hours, or 6 hours) by utilizing the past power usage data provided by the building manager 20.

Depending on the power measurement device (e.g., AMI, power measurement sensor, or the like), the prediction time unit may vary, such as 15 minutes, 30 minutes, or 1 hour.

The building power prediction module 120 may predict the power usage pattern by applying various prediction models utilizing an artificial intelligence from a linear prediction model.

When the data is insufficient, the building power prediction module 120 may improve the power prediction performance of corresponding building by using power consumption information of another building.

The required power estimation module 130 may calculate a time zone in which an additional power is required for each of the buildings and a required amount of electrical power based on the collected power data and the predicted power consumption.

The required power estimation module 130 may estimate the time zone requiring discharging of each of the buildings and the amount of electrical power, in consideration of the power facility data and the contacted power data with respect to each of the buildings.

For example, when the predicted amount of electrical power calculated by the building power prediction module 120 is higher than the capacity of the power facility or the contracted amount of electrical power, the required power estimation module 130 may estimate that electrical power is required in that time zone as much as a value obtained by subtracting the contracted amount of electrical power or equipment capacity from the predicted amount of electrical power.

The travel demand estimation module 140 may estimate the travel demand of a region where the buildings exist.

Because the ride-sharing service may be used as one of the public transportation means, the travel demand estimation module 140 may collect public transportation data by time according to regions.

Although the travel demand estimation module 140 may only utilize the conventional public traffic data in an initial service, when the service period is continued, it may also utilize service participation record information.

That is, the travel demand estimation module 140 may collect public transportation demand data and the ride-sharing service participation record data according to regions, for each time zone, to generate the travel demand information.

The travel demand estimation module 140 may estimate an actual travel demand when the ride-sharing vehicle performs movement between building in consideration of the generated travel demand information.

The travel demand estimation module 140 may estimate the travel demand through Equation 1 below by using the number of persons to depart from a departure region and the number of persons to move to another region.

$${X}_{A \to B} = \frac{Arrival {quantity}_{B}}{{\sum }_{n \neq A} Arrival {quantity}_{B}} \times Departure {quantity}_{A} \qquad [ Equation 1 ]$$

Here, A and B denote buildings, X denotes a travel demand quantity, X_{A→B} denotes a travel demand quantity when moving from A to B, and n denotes a set of all buildings. Here, an Arrival quantity_{B} is the number of persons moving to a building B, an Arrival quantityₙ is the number of persons moving to all the buildings, and a Departure quantity_{A} is the number of persons to depart from a building A.

The travel path setting module 150 may set a travel path of the ride-sharing vehicle for each time zone within the region based on a time zone requiring the additional power, the required amount of electrical power, and the travel demand.

The travel path setting module 150 may set a travel path maximizing profitability, and the profitability may be calculated through Equation 2 below.

$$profitability = passenger boarding fee + electric vehicle disharging fee + service fee of building manager - electric vehicle battery degradation cost - electric vehicle charging cost - electric vehicle operating cost \qquad [ Equation 2 ]$$

The travel path setting module 150 may use an optimization model including reinforcement learning, auction model, and linear programming in order to set the travel path.

The electric vehicle charging and discharging apparatus 100 linking the ride-sharing service and the V2G may guide a predetermined path to the customer terminal.

When a user requests reservation to use the ride-sharing service in the guided path, the electric vehicle charging and discharging apparatus 100 linking the ride-sharing service and the V2G may perform reservation with respect to a passenger to use the ride-sharing vehicle according to path predetermined for each time zone.

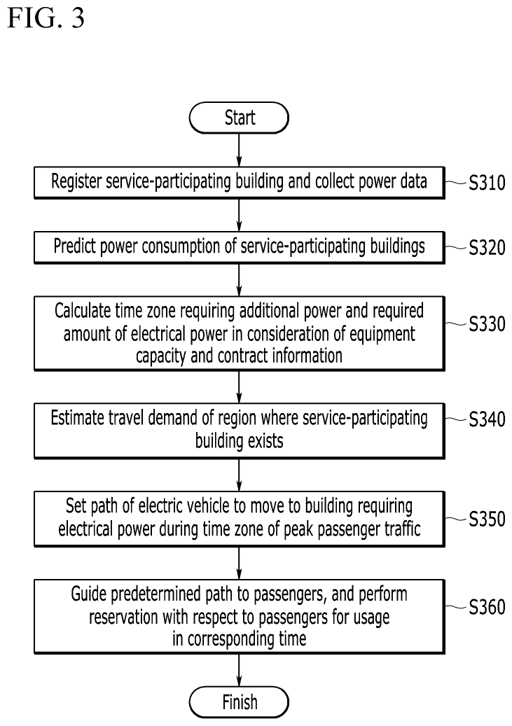

FIG. 3 is a flowchart of an electric vehicle charging and discharging method linking the ride-sharing service and the V2G according to an embodiment. The electric vehicle charging and discharging method linking the ride-sharing service and the V2G may be performed through the electric vehicle charging and discharging apparatus 100 of FIG. 2 linking the ride-sharing service and the V2G.

In FIG. 3, at step S310, the electric vehicle charging and discharging apparatus 100 linking the ride-sharing service and the V2G may collect the registration and power data of the service-participating building.

Here, service-participating building may correspond to the buildings input or registered through application, or the like in order to participate in the electric vehicle charging and discharging service linking the ride-sharing service and the V2G.

The electric vehicle charging and discharging apparatus 100 linking the ride-sharing service and the V2G may perform registration with respect to the buildings participating in the service by regions.

The electric vehicle charging and discharging apparatus 100 linking the ride-sharing service and the V2G may collect the location data of each of the buildings, for estimating the past power usage data, the power facility data, the contacted power data and the travel demand of each of the buildings, for power prediction.

At step S320, the electric vehicle charging and discharging apparatus 100 linking the ride-sharing service and the V2G may predict power consumption of the buildings participating in the service.

The electric vehicle charging and discharging apparatus 100 linking the ride-sharing service and the V2G may predict power consumption of each of the buildings participating in the service by using various prediction models using the artificial intelligence.

The electric vehicle charging and discharging apparatus 100 linking the ride-sharing service and the V2G may output power consumption of the building for a specific period by inputting the past power data of the building into the prediction model.

At step S330, the electric vehicle charging and discharging apparatus 100 linking the ride-sharing service and the V2G may calculate the time zone requiring the additional power and the amount of electrical power in consideration of the equipment capacity and the contract information.

The electric vehicle charging and discharging apparatus 100 linking the ride-sharing service and the V2G may estimate the time zone requiring discharging of each of the buildings and the amount of electrical power, in consideration of the power facility data and the contacted power data with respect to each of the buildings.

At step S340, the electric vehicle charging and discharging apparatus 100 linking the ride-sharing service and the V2G may estimate the travel demand of the region where the service-participating building exists.

The electric vehicle charging and discharging apparatus 100 linking the ride-sharing service and the V2G may collect the public transportation demand data and the ride-sharing service participation record data according to regions, for each time zone, to generate the travel demand information, and may estimate the actual travel demand when the ride-sharing vehicle performs movement between buildings in consideration of the generated travel demand information. The travel demand may be represented as the number of persons.

The electric vehicle charging and discharging apparatus 100 linking the ride-sharing service and the V2G may estimate the travel demand through Equation 1.

$${X}_{A \to B} = \frac{Arrival {quantity}_{B}}{{\sum }_{n \neq A} Arrival {quantity}_{B}} \times Departure {quantity}_{A} \qquad [ Equation 1 ]$$

A and B denote buildings, X denotes a travel demand quantity, denotes a travel demand quantity when moving from A to B, n denotes a set of all buildings. The Arrival quantity_{B} is the number of persons moving to the building B, and the Arrival quantityₙ is the number of persons moving to all the buildings, and the Departure quantity_{A} is the number of persons to depart from the building A.

At step S350, the electric vehicle charging and discharging apparatus 100 linking the ride-sharing service and the V2G may set the path of the electric vehicle to be able to move to the building requiring the electrical power at a time zone where the number of passengers is the highest.

The electric vehicle charging and discharging apparatus 100 linking the ride-sharing service and the V2G may set a travel path maximizing profitability.

The profitability may be calculated through Equation 2 below.

$$profitability = passenger boarding fee + electric vehicle disharging fee + service fee of building manager - electric vehicle battery degradation cost - electric vehicle charging cost - electric vehicle operating cost \qquad [ Equation 2 ]$$

That is, the profitability may be calculated by subtracting a sum of the electric vehicle battery degradation cost, the electric vehicle charging cost, and the electric vehicle operating cost from a sum of the passenger boarding fee, the electric vehicle discharging fee, and the service fee of building manager.

At step S360, the electric vehicle charging and discharging apparatus 100 linking the ride-sharing service and the V2G may guide a predetermined path to the passenger, and may perform reservation with respect to passengers to use the ride-sharing vehicle traveling along corresponding path at a corresponding time.

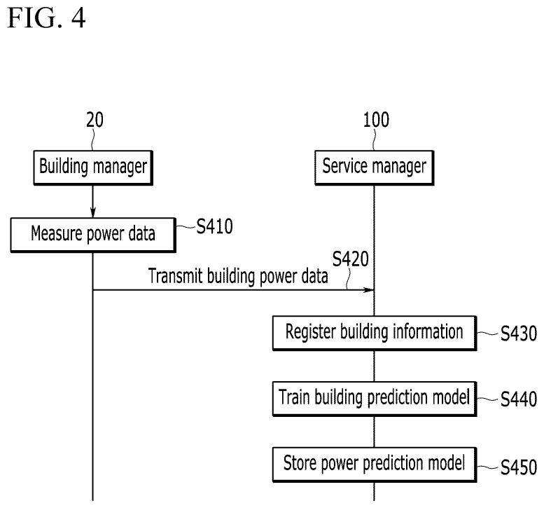

FIG. 4 is a drawing showing a signal flow of a process of collecting data of a service-participating building according to an embodiment. FIG. 4 shows a signal flow between the building manager 20 and the service manager 100.

In FIG. 4, at step S410, the building manager 20 may measure the power data of the buildings participating in the service.

At step S420, the building manager 20 may transmit the measured power data to the service manager 100.

At step S430, the service manager 100 may register building information with the power data of the buildings participating in the service.

At step S440, the service manager 100 may train building prediction model based on the received power data and the registered building information.

At step S450, the service manager 100 may store the generated power prediction model. The stored prediction model may be update during the servicing process.

The power prediction model may be applied in various manners and form a linear prediction model to a prediction model using the artificial intelligence, or the like.

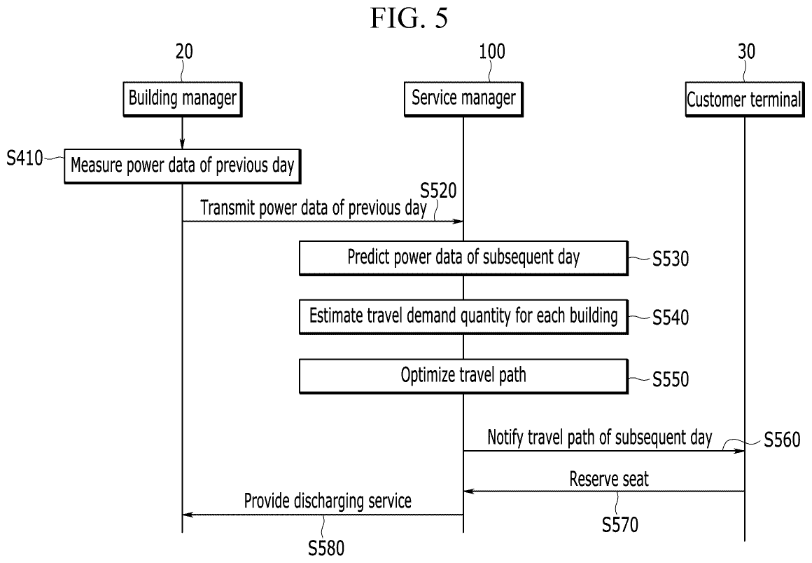

FIG. 5 is a drawing showing a signal flow of an electric vehicle charging and discharging method linking the ride-sharing service and the V2G according to an embodiment.

FIG. 5 shows a signal flow in providing an electric vehicle charging and discharging service linking the ride-sharing service and the V2G between the building manager 20, the service manager 100, and the customer terminal 30.

The service manager 100 may provide the electric vehicle charging and discharging service linking the ride-sharing service and the V2G, which notifies the travel path to the customer terminal 30 by a day unit. The temporal period of the service provision may be variably determined depending on applications.

The service manager 100 may have to collect the power data of the previous day in order to predict the power data of the subsequent day.

In FIG. 5, at step S510, the building manager 20 may measure the power data of the buildings of the previous day, which is previous by one day.

At step S520, the building manager 20 may transmit the measured power data of the previous day to the service manager 100.

At step S530, the service manager 100 may predict the power data of the subsequent day of the buildings based on the power data of the previous day.

The service manager 100 may predict power consumption of the subsequent day by utilizing the power prediction model.

Because the prediction performance may be degraded after a preset period has elapsed since the prediction model was trained, the service manager 100 may perform learning again with data collected during the service period.

At step S540, the service manager 100 may estimate the travel demand quantity for each building.

The service manager 100 may use the public transportation data or the demand data generated during the service period in order to estimate the travel demand quantity for each building.

The service manager 100 may estimate the travel demand quantity (arrival quantity, departure quantity) for each time zone and for each building and utilize it to the service.

At step S550, the service manager 100 may optimize a travel path based on the travel demand quantity.

The service manager 100 may estimate the travel demand quantity, and search a path where a large number of passengers can occur. In addition, the service manager 100 may estimate the time for the building manager 20 require the electrical power, and based on this, may search the path.

That is, the service manager 100 may set a path simultaneously satisfying two conditions of the path where the largest number of passengers occur and a path capable of providing the electrical power to a building manager 200 at a proper time, in an optimization method.

The service manager 100 may utilize reinforcement learning, auction model, linear programming, or the like, for the path optimization.

At step S560, the service manager 100 may notify the optimized travel path to the customer through the customer terminal 30.

At step S570, the customer may request seat reservation of the ride-sharing vehicle to the service manager 100 through the customer terminal 30.

At step S580, the service manager 100 may provide the discharging service to the building manager 20.

The service manager 100 may perform seat reservation, and may provide the discharging service, in which the electric vehicle may visit the corresponding building to discharge the electrical power at the time zone requiring the additional power, to the building manager 20.

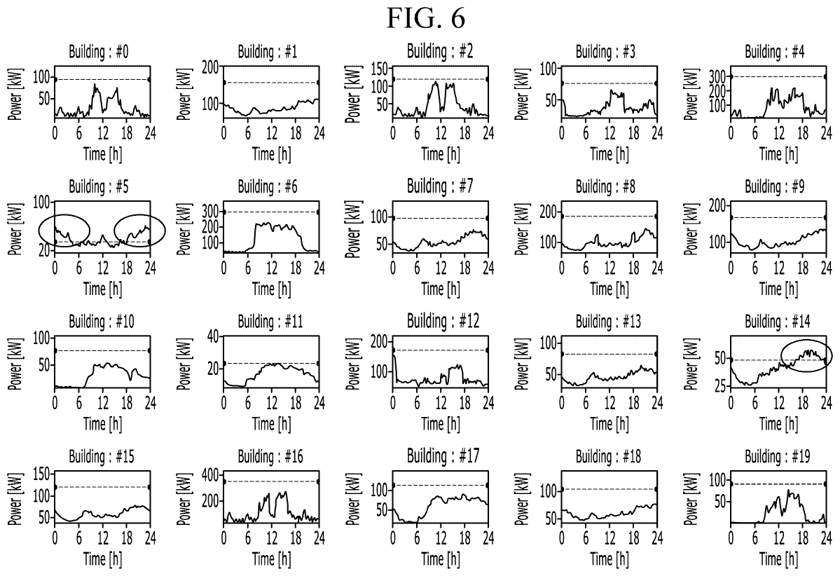

FIG. 6 shows graphs of the power data of the buildings according to an embodiment.

Each of graphs of FIG. 6 shows the capacity of the power facility (or contracted electrical power) and a power consumption per day, with respect to the buildings of number 0 to 19.

In the graph, the dotted line may represent the equipment capacity or the contracted electrical power, and the solid line may represent power consumption per day. A total of twenty buildings may be distinguished through the building number.

In an embodiment, the service manager 100 may estimate the time zone requiring discharging and the amount of electrical power, in consideration of the collect power facility, contracted electrical power, or the like for each building.

For example, when the predicted amount of electrical power calculated from the building power prediction module 120 (see FIG. 2) is higher than the capacity of the power facility or the contracted amount of electrical power as in Building #5 and/or Building #14, the required power estimation module 130 (see FIG. 2) may estimate that the electrical power is required as much as predicted electrical power at that time zone-contracted/facility capacity.

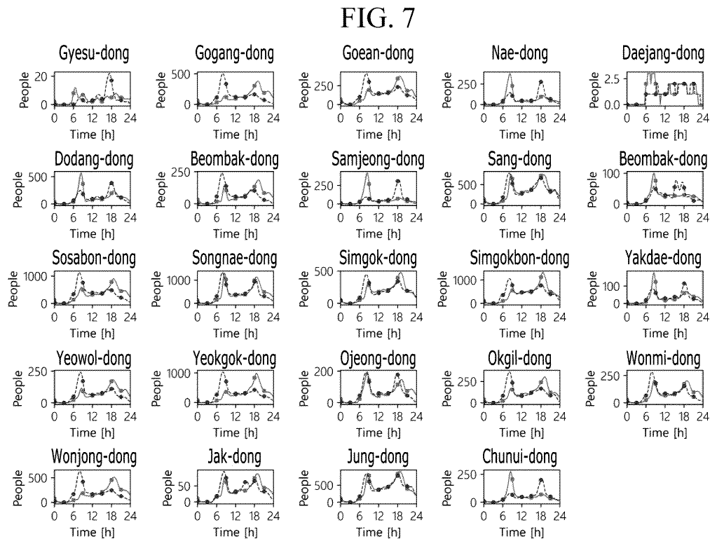

FIG. 7 shows graphs of public transportation usage by regions according to an embodiment.

The graphs show the travel demand of persons in different regions by time zone, respectively.

Because the ride-sharing service of the present disclosure may be used as the one of the public transportation means, collecting of the public transportation data according to regions by time zone is necessary.

The service manager 100 may utilize the travel demand information for each collected region to estimate the travel demand of passengers between the buildings between regions.

For example, the service manager 100 may estimate the travel demand quantity by using the number of persons to depart from the departure region and the number of persons to move to another region.

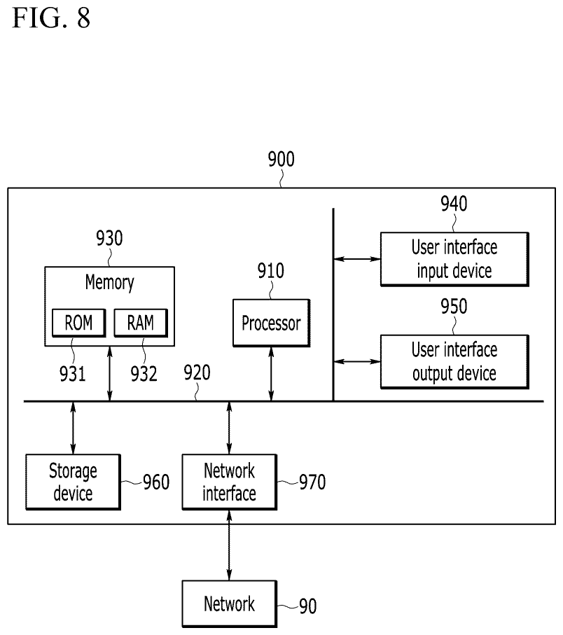

FIG. 8 is drawing for explaining a computing device according to an embodiment.

Referring to FIG. 8, the electric vehicle charging and discharging apparatus and method linking the ride-sharing service and the V2G according to embodiments may be implemented by using a computing device 900.

The computing device 900 may include at least one of a processor 910, a memory 930, the user interface input device 940, the user interface output device 950 and a storage device 960 that communicate through a bus 920. The computing device 900 may also include a network interface 970 electrically connected to a network 90. The network interface 970 may transmit or receive signals with other entities through the network 90.

The processor 910 may be implemented in various types such as a micro controller unit (MCU), an application processor (AP), a central processing unit (CPU), a graphic processing unit (GPU), a neural processing unit (NPU), and the like, and may be any type of semiconductor device capable of executing instructions stored in the memory 930 or the storage device 960. The processor 910 may be configured to implement the functions and methods described above with respect to FIG. 1 to FIG. 7.

The memory 930 and the storage device 960 may include various types of volatile or non-volatile storage media. For example, the memory may include read-only memory (ROM) 931 and a random-access memory (RAM) 932. In this embodiment, the memory 930 may be located inside or outside processor 910, and the memory 930 may be connected to the processor 910 through various known means.

In some embodiments, at least some configurations or functions of an electric vehicle charging and discharging apparatus and method linking ride-sharing service and vehicle-to-grid according to an embodiment may be implemented as a program or software executable by the computing device 900, and program or software may be stored in a computer-readable medium.

In some embodiments, at least some configurations or functions of an electric vehicle charging and discharging apparatus and method linking ride-sharing service and vehicle-to-grid according to an embodiment may be implemented by using hardware or circuitry of the computing device 900, or may also be implemented as separate hardware or circuitry that may be electrically connected to the computing device 900.

While this disclosure has been described in connection with what is presently considered to be practical embodiments, it is to be understood that the disclosure is not limited to the disclosed embodiments, but, on the contrary, is intended to cover various modifications and equivalent arrangements included within the spirit and scope of the appended claims.

What is claimed is:

1. An electric vehicle charging and discharging apparatus for linking ride-sharing service and vehicle-to-grid, comprising:
a processor; and
a memory storing software, when executed by the processor, causing the processor to:
collect power data of buildings,
predict power consumption of the buildings based on the power data, respectively,
calculate a time zone in which an additional power is required for each of the buildings and a required amount of electrical power based on the collected power data and the predicted power consumption,
estimate a travel demand of a region where the buildings exist, and
set a travel path of a ride-sharing vehicle for each time zone within the region based on the time zone requiring the additional power, the required amount of electrical power and the travel demand.

2. The apparatus of claim 1, wherein the processor is configured to collect location data of respective buildings for estimation of past power usage data, power facility data, contacted power data and the travel demand of respective buildings, for power prediction.

3. The apparatus of claim 2, wherein the processor is configured to predict a power usage pattern during a specific period for each of the buildings by using the collected past power usage data.

4. The apparatus of claim 2, wherein the processor is configured to estimate the time zone requiring discharging of each of the buildings and the amount of electrical power in consideration of the power facility data and the contacted power data with respect to each of the buildings.

5. The apparatus of claim 1, wherein the processor is configured to collect public transportation demand data and ride-sharing service participation record data according to regions, for each time zone, to generate travel demand information.

6. The apparatus of claim 5, wherein the processor is configured to estimate an actual travel demand when the ride-sharing vehicle performs movement between building in consideration of the generated travel demand information.

7. The apparatus of claim 6, wherein:
the processor is configured to estimate the travel demand through Equation 1 below by using the number of persons to depart from a departure region and the number of persons to move to another region,
$${X}_{A \to B} = \frac{Arrival {quantity}_{B}}{{\sum }_{n \neq A} Arrival {quantity}_{B}} \times Departure {quantity}_{A} \qquad [ Equation 1 ]$$
wherein A and B denote buildings, X denotes a travel demand quantity, denotes a travel demand quantity when moving from A to B, n denotes a set of all buildings, an Arrival quantity_{B} is the number of persons moving to a building B, an Arrival quantityₙ is the number of persons moving to all the buildings, and a Departure quantity_{A} is the number of persons to depart from a building A.

8. The apparatus of claim 1, wherein the processor is configured to set a travel path maximizing profitability, and
wherein the profitability is calculated through Equation 2 below,
$$profitability = passenger boarding fee + electric vehicle disharging fee + a service fee of building manager - electric vehicle battery degradation cost - electric vehicle charging cost - electric vehicle operating cost . \qquad [ Equation 2 ]$$

9. The apparatus of claim 1, wherein the processor is configured to use an optimization model comprising reinforcement learning, auction model, and linear programming, in order to set the travel path.

10. The apparatus of claim 1, wherein the processor is configured to guide the predetermined path to a customer terminal, and perform reservation with respect to a passenger to use the ride-sharing vehicle according to the path predetermined for each time zone.

11. An electric vehicle charging and discharging method for linking ride-sharing service and vehicle-to-grid, comprising:
collecting power data of buildings;
predicting power consumption of the buildings based on the power data, respectively;
calculating a time zone in which an additional power is required for each of the buildings and a required amount of electrical power based on the collected power data and the predicted power consumption;
estimating a travel demand of a region where the buildings exist; and
setting a travel path of a ride-sharing vehicle for each time zone within the region based on the time zone requiring the additional power, the required amount of electrical power and the travel demand.

12. The method of claim 11, wherein the collecting the power data comprises collecting location data of respective buildings for estimation of past power usage data, power facility data, contacted power data and the travel demand of respective buildings, for power prediction.

13. The method of claim 12, wherein the predicting the power consumption of the buildings, respectively, comprises predicting a power usage pattern during a specific period for each of the buildings by using the collected past power usage data.

14. The method of claim 12, wherein in the calculating the time zone requiring the additional power and the required amount of electrical power, the time zone requiring discharging of each of the buildings and the amount of electrical power are estimated in consideration of the power facility data and the contacted power data with respect to each of the buildings.

15. The method of claim 11, wherein the estimating the travel demand comprises generating travel demand information by collecting public transportation demand data and ride-sharing service participation record data according to regions, for each time zone.

16. The method of claim 15, wherein the estimating the travel demand further comprises estimating an actual travel demand when the ride-sharing vehicle performs movement between building in consideration of the generated travel demand information.

17. The method of claim 16, wherein the estimating the travel demand further comprises estimating the travel demand through Equation 1 below by using the number of persons to depart from a departure region and the number of persons to move to another region,
$${X}_{A \to B} = \frac{Arrival {quantity}_{B}}{{\sum }_{n \neq A} Arrival {quantity}_{B}} \times Departure {quantity}_{A} \qquad [ Equation 1 ]$$
wherein A and B denote buildings, X means a travel demand quantity, X_{A→B denotes a travel demand quantity when moving from A to B, and n denotes a set of all buildings, wherein an Arrival quantity}_{B} is the number of persons moving to a building B, an Arrival quantityₙ is the number of persons moving to all the buildings, and a Departure quantity_{A} is the number of persons to depart from a building A.

18. The method of claim 11, wherein the setting the travel path comprises setting a travel path maximizing profitability,
wherein the profitability is calculated through Equation 2 below:
$$profitability = passenger boarding fee + electric vehicle disharging fee + a service fee of building manager - electric vehicle battery degradation cost - electric vehicle charging cost - electric vehicle operating cost . \qquad [ Equation 2 ]$$

19. The method of claim 11, wherein the setting the travel path comprises setting the travel path by using an optimization model comprising reinforcement learning, auction model, and linear programming.

20. The method of claim 11, further comprising guiding a predetermined path to a customer terminal, and performing reservation with respect to a passenger to use the ride-sharing vehicle according to the path predetermined for each time zone.
